(19) United States
(12) Patent Application Publication
(10) Pub. No.: US 2004/0009758 A1
(43) Pub. Date: Jan. 15, 2004

(54) Fast attack automatic gain control (AGC) circuit for narrow band systems

(76) Inventors: David James Graham, Gilbert, AZ (US); Victor Korol, Petach Tiqva (IL); Mark Rozental, Gedera (IL)

Correspondence Address: MOTOROLA, INC., 1303 EAST ALGONQUIN ROAD, IL01/3RD, SCHAUMBURG, IL, 60196

(21) Appl. No.: 10/460,216

(22) Filed: Jun. 12, 2003

Related U.S. Application Data
(63) Continuation-in-part of application No. 09/614,668, filed on Jul. 12, 2000, now abandoned.

(51) Int. Cl. H04B 1/06

(52) U.S. Cl. 455/234.1; 455/232.1

(57) ABSTRACT

Apparatus and a method for fast attack automatic gain control (AGC) loop for narrow band systems in which RF signals are received in discontinuous bursts, such as TETRA systems in a direct mode of operation (DMO). The loop includes a feedback loop with a predetermined non-linear response to an input signal. The method includes the steps of opening the AGC loop (250), setting a gain for the signal path of the AGC loop to a predetermined level (252), closing the AGC loop (254) and commencing a steady-state mode of operation (258).

### CROSS-REFERENCE TO RELATED APPLICATIONS

This Application is a continuation in part of pending U.S. patent application Ser. No. 09/614,668 filed Jul. 12, 2000 for Fast Attack Automatic Gain Control (AGC) Loop For Narrow Band Systems.

### BACKGROUND OF THE INVENTION

(a) Field of the Invention The present invention relates to narrow band receivers of radio communication systems, in general, and to methods and systems for narrow band receivers that employ automatic gain control, in particular.

A radio communication system includes, as a minimum, a transmitter and a receiver. The transmitter and the receiver are interconnected by a radio-frequency wireless channel, which provides transmission of an informative signal therebetween. A digital receiver generally includes an amplifier, which is coupled to the front end and includes a receiving element (an antenna). The amplifier is characterized by a gain, which can be adjusted in a predetermined range, using a control signal. Most receivers also include a unit, which automatically adjusts the gain of the amplifier according to the level of the received signal. The process of adjusting the gain, according to which a received signal should be amplified, is called Automatic Gain Control (AGC).

In Time Division Multiple Access (TDMA) systems, an RF channel is shared among numerous subscribers attempting to access the radio system in certain of the time-division-multiplexed time slots. This enables transmission of more than one signal at the same frequency, using the sequential time-sharing of a single channel by several subscribers. The time slots are arranged in periodically repeating frames.

Each of the frames includes a certain amount of slots and each of the slots provides a signal for a specified subscriber.

For example, in TETRA mobile communication systems, which operate in accordance with TETRA (TErrestrial Trunked Radio) standards or operating protocols which have been defined by the European Telecommunications Standards Institute (ETSI), transmissions to and from mobile terminals are controlled in a synchronized time slot mode. The slot duration for a traffic (voice, data etc) channel is 14.167 ms. Four slots represent four physical channels in a TDMA (time division multiple access) protocol and form one time frame of duration 56.67 ms in an 18 time frame multiframe timing structure.

TETRA systems can operate in a trunked mode of operation (TMO) in which communication signals are sent between mobile terminals via a fixed infrastructure including one or more base stations. Alternatively, such systems can operate in a Direct Mode Operation (DMO) by direct communication between the terminals without the infrastructure. As noted earlier, the TETRA protocol operates using a four slot per frame TDMA format in the timing sequence. Each slot is assigned to a different subscriber. In TETRA TMO each receiving terminal continuously receives a RF signal from the infrastructure during the four slots of each frame. In contrast, in DMO a receiving terminal does not receive a continuous RF signal but receives a RF signal in only one slot per frame. TETRA DMO systems therefore require either a receiver that has a dynamic range, large enough to account for all signal levels, or a receiver with a very fast AGC, which can adapt very rapidly to changing levels of received signals. The desired response time of the AGC loop has to be less than 0.2 ms.

(b) Description of Related Art

U.S. Pat. No. 5,742,899 to Blackburn et al., entitled “Fast Attack Automatic Gain Control (AGC) Loop for Narrow Band Receiver” is directed to a fast attack AGC loop having a first feedback loop with selectable response shapes and a second feedback loop with selectable response shapes. Response shape selection is based upon fast pull-down operation mode, overshoot recovery operation mode and steady state operation mode. The system described in the patent is dedicated for operating in TDMA, and its response time is 1.5 ms for 25 kHz intermediate frequency baseband. The system has been optimized for the case when there is continuous transmission of RF power, thus allowing AGC settling to occur at the end of a time slot, which preceded the desired time slot.

U.S. Pat. No. 5,724,652 to Graham et al (one of the present inventors) describes a method of acquiring a rapid AGC response in a narrow band receiver. Such a method is also aimed at use in a receiver in a system in which RF power is received in continuous bursts.

The prior art circuits and methods are therefore unsuitable for direct use in systems in which the the RF power is transmitted/received in discontinuous bursts. It would be advantageous to provide a circuit and a method and which will provide fast AGC settling in such systems, for example (but not limited to) the TETRA Direct Mode Operation DMO.

### SUMMARY OF THE PRESENT INVENTION

It is an object of the present invention to provide a novel circuit and method for fast automatic gain control (AGC) in narrow band receivers. In accordance with the present invention, there is thus provided a fast attack AGC (AGC) circuit for a narrow band receiver being in an idle mode of operation. The AGC circuit includes a forward transmission path having an amplifier, responsive to reception of a control signal, which alters a gain of the amplifier, by application of a control signal at a control input. The forward transmission path receives an RF signal at a signal input and provides a baseband signal at a signal output. The RF signal is provided in a plurality of signal time slots, each pair of adjacent slots in which the signal is received being interleaved by at least one empty slot. The baseband signal rceived includes quadrature components, i.e. in-phase (I) component and quadrature (Q) component.

The AGC circuit includes:

a feedback path, coupled to the output of the forward transmission path and to the control input of the amplifier,

an integrating circuit, coupled to the control input of the amplifier, and,

a voltage source, coupled to the integrating circuit and to the control input of the amplifier.

The feedback loop incorporates a signal detector that has a predetermined non-linear gain response, which is a function of an input signal level. The gain is higher for high-level signals and lower for low-level signals.

In accordance with another aspect of the present invention, there is provided an AGC loop for a narrow band receiver, being in an idle mode of operation. The AGC loop includes a forward transmission path having an amplifier and a low-pass filter. The low-pass filter is coupled to an output of the amplifier. The amplifier is responsive to reception of a control signal at a control input. The control signal alters a gain of the amplifier. The amplifier receives an RF signal at an input of the amplifier and provides at the output of the amplifier a signal for conversion by a downconverter to a baseband signal. The RF signal is provided as a plurality of signal slots, each pair of adjacent slots of this plurality being interleaved by at least one empty slot.

The AGC loop includes:

a first feedback path, coupled to the output of the forward transmission path and to the control input of the amplifier;

a second feedback path, coupled to the output of the amplifier and to the control input of the amplifier;

an integrating circuit, coupled to the control input of the amplifier; and,

a voltage source, coupled to the integrating circuit and to the control input of the amplifier,

The first feedback loop and the second feedback loop incorporate signal detectors that have a predetermined non-linear gain response, depending on an input signal level. The gain is higher for high-level signals and lower for low-level signals.

In accordance with a further aspect of the present invention, there is provided a method for operating an AGC loop in a narrow band receiver being in an idle mode of operation. The AGC loop includes an amplifier, which is responsive to reception of a control signal, having an amplitude. The narrow band receiver receives RF signals, which are provided as a plurality of signal slots, each pair of adjacent slots being interleaved by at least one empty slot. The methods includes the steps of:

setting the AGC loop to an opened operation mode;

setting the control signal amplitude to a predetermined value; and,

setting the AGC loop to a closed operation mode.

A key beneficial feature of the present invention is capitalizing on the characteristics of the non-linear signal detector response. The detector has a self adjusting variable gain. The loop including the detector responds very quickly while saturated, and then naturally and continuously slows down as the signal level approaches the desired settling point. Another key beneficial feature is that the large signal AGC response operates in a non-linear manner giving a very quick AGC response, while the small signal AGC response can be accurately approximated as linear—thus allowing fast settling and good closed loop performance with a single detector and AGC loop.

Thus the present invention beneficially provides a novel circuit and method for use in providing AGC in a receiver for receiving RF signals in discontinuous bursts in a narrow band system, thereby providing suitable fast attack and settling following detection of each burst. The invention is suitable for use in TETRA DMO systems or any other systems operating in a time divided manner wherein RF signals in are received in discontinuous bursts, particularly systems operating in a manner which does not include amplitude information in the modulation protocol.

### BRIEF DESCRIPTION OF THE DRAWINGS

The present invention will be understood and appreciated more fully from the following detailed description taken in conjunction with the drawings in which:

FIG. 1 is a schematic illustration of a fast attack automatic gain control (AGC) loop, constructed and operative in accordance with a preferred embodiment of the present invention;

FIG. 2 is a graphical illustration of relationship between signal level and AGC detector gain in the AGC loop of FIG. 1, constructed and operative in accordance with a further preferred embodiment of the present invention;

FIG. 3 is a schematic illustration of a method for operating the AGC loop of FIG. 1, operative in accordance with another preferred embodiment of the present invention;

FIG. 4 is a graphical illustration of modes of operation of the system of FIG. 1, constructed and operative in accordance with a preferred embodiment of the present invention; and,

FIG. 5 is a schematic illustration of a system, constructed and operative in accordance with a further preferred embodiment of the present invention.

### DETAILED DESCRIPTION OF THE INVENTION

The present invention overcomes the disadvantages of the prior art by providing an apparatus and method for fast attack automatic gain control for narrow band systems with response time less than 0.2 ms.

Reference is now made to FIG. 1, which is a schematic illustration of a fast attack AGC loop, generally referenced 200, constructed and operative in accordance with a preferred embodiment of the present invention.

An AGC loop 200 includes an AGC amplifier 210, a down mixer 212, a driver 216, an AGC detector 218, a controller 226, a damping resistor R_{AGC} 230, an integrating capacitor C_{AGC} 232, a voltage source V_{PRESET} 234 and three switches 236, 238 and 244. AGC amplifier 210 is coupled to down mixer 212 and to driver 216. AGC detector 218 is coupled to down mixer 212 and to switch 244. Controller 226 is coupled to switches 236, 238 and 244. Driver 216 is coupled to switches 238 and 244. Voltage source V_{PRESET} 234 is coupled to switch 236. Damping resistor R_{AGC} 230 is coupled to integrating capacitor C_{AGC} 232 and to switch 238.

The input to AGC loop 200 is an RF signal. AGC amplifier 210 receives the input signal, amplifies it and provides an output to down mixer 212. The output of down mixer 212 is typically a complex baseband signal, having quadrature components, i.e. in-phase (I) component and quadrature (Q) component. Driver 216 controls the gain of AGC amplifier 210 by providing a control signal 240. An exemplary dependence of the attenuation of AGC amplifier 210 on the voltage on integrating capacitor C_{AGC} 232, can be a linear dependence of the decibels of attenuation on voltage. It is noted that there can be other types of dependencies of the attenuation of AGC amplifier 210 on the voltage on integrating capacitor C_{AGC} 232.

The value of control signal 240 depends on the operation mode of AGC loop 200. Detailed description of each of two operation modes is presented below.

At the beginning of a first operation mode, which corresponds to time instances preceding the RF signal slot, AGC loop 200 is open, hence the feedback loop is not operative. At this stage, switch 244 is open and switches 236 and 238 are closed. Voltage source V_{PRESET} 234 charges integrating capacitor C_{AGC} 232. The voltage value is determined so that the attenuation of AGC amplifier 210 will be minimal. Typically, the attenuation value is equal to zero. The time required for charging integrating capacitor C_{AGC} 232 is specified by a product of damping resistor R_{AGC} 230 value and integrating capacitor C_{AGC} 232 value. The first operation mode is terminated when the charging of integrating capacitor C_{AGC} 232 is completed.

At the beginning of a second operation mode, controller 226 opens switch 236, thereby disconnecting voltage source V_{PRESET} 234 from integrating capacitor C_{AGC} 232. The remainder of the charge at integrating capacitor C_{AGC} 232 defines the value of control signal 250 and hence, the gain (or attenuation) of AGC amplifier 210. Controller 226 further closes switch 244, thereby closing AGC feedback loop. AGC detector 218 is a self adjusting variable gain detector. It determines a level of the sum of squares of the I and Q signals, and provides an output signal to integrating capacitor C_{AGC} 232. The voltage at integrating capacitor C_{AGC} 232 determines the gain of AGC amplifier 210. The beginning of the second operation mode falls in time instances preceding the RF signal slot. AGC detector 218 will first detect an ambient noise of the system. Upon detection of this signal, AGC detector 218 provides a respective output signal to AGC amplifier 210, thereby increasing the attenuation of the signal.

The shape of the gain response of AGC detector 218 and hence the open loop gain of AGC loop 200 (which is proportional to the gain of AGC detector 218) depends in a non-linear manner on the signal level. This gain is higher for signals that are greater than a desired signal value (AGC threshold) and vice versa. An exemplary rule for the gain variation is of the following form:

G=G₀+kS^{1+r} (1)

where G is the detector gain, S is the signal level and G₀, k and r are predetermined parameters relating to the response. G₀ and k relate to the zero order and first order gain. The parameter r corresponds to the nonlinear shape of the detector response. For example, a square law detector would have r=1. It is noted that r can be a function of S.

It is well known in the field that the loop bandwidth of a closed loop system is related to the derivative of the open loop gain. As described, the open loop gain of the new system depends on the signal level. The bandwidth of AGC loop 200 also depends on the signal level. For r greater or equal to one, the derivative of the loop gain will also be a function of signal input. Thus, the bandwidth of the AGC loop 200 also depends on the signal level. Since in the DMO mode the slot which precedes a RF signal slot is generally empty, AGC loop 200 must be able to adapt itself to very fast changing signal levels. The signal rise time period can be less than 0.2 ms and the dynamic range of the signal can exceed 80 dB. This requires the loop bandwidth to be maximal for high level signals, so that the AGC attack (settling) time would be less than 0.2 ms. The attack time of AGC loop 200 is the time period, which is required for the AGC loop to reach steady state operation in response to an arbitrary input power level or to an arbitrary change in input power level. Typically, the dependence of the loop bandwidth on the signal level can be proportional to the derivative of the loop gain with respect to the signal level, and is of a form:

BW=A. k. (1+r) S^{r} (2)

where BW is a loop bandwidth, A is a predetermined parameter and r, S and k are as defined previously.

The settling time of AGC loop 200 depends on the value of integrating capacitor C_{AGC} 232. The value of A in equation 2 Is proportional to the reciprocal of the capacitance value of C_{AGC} 232. To minimize the settling time, the capacitance value of integrating capacitor C_{AGC} 232 must be as small as possible while still maintaining a stable loop. A practical limit for the capacitance value of integrating capacitor C_{AGC} 232 is set by the loop dynamics. If the value of integrating capacitor C_{AGC} 232 is too small, then there is a significant overshoot in the loop response, which leads to signal distortions at the beginning of the receive slot. This problem can be solved by connecting damping resistor R_{AGC} 230 in series with integrating capacitor C_{AGC} 232. This connection improves the stability of the AGC loop and reduces its response time.

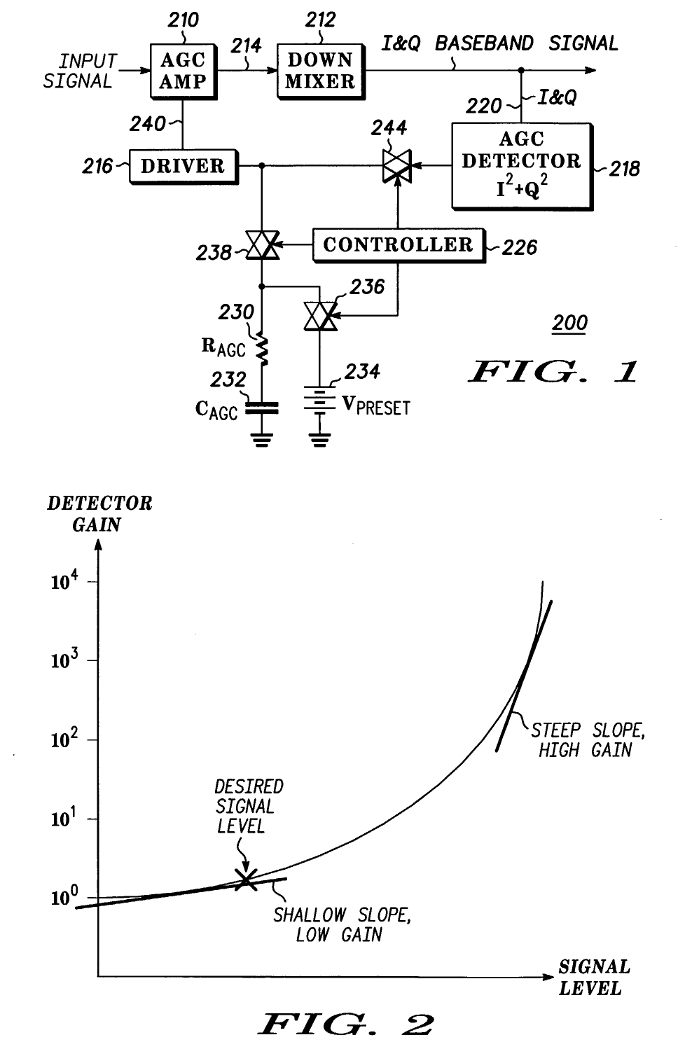

Reference is now made to FIG. 2, which is a graphical illustration of the dependence of AGC loop 200 gain on the signal level, in accordance with the preferred embodiment of the present invention (FIG. 1).

Typically, the dependence of AGC loop 200 gain on the signal level is determined by the response of detector 218 which can be governed by equation (1). For signal levels that are below a desired signal level (AGC threshold), the gain variations of AGC loop 200 are comparatively small. When the signal level exceeds the AGC threshold, the gain of AGC loop 200 begins to increase sharply. The slope of the curve, which is proportional to AGC loop 200 bandwidth, is high (steep) for large signals and low (shallow) for small signals. It enables AGC loop 200 to have a fast response for signals which exceed the desired signal level and a slow response for low-level signals (including noise). The second operation mode continues until the end of the RF signal slot.

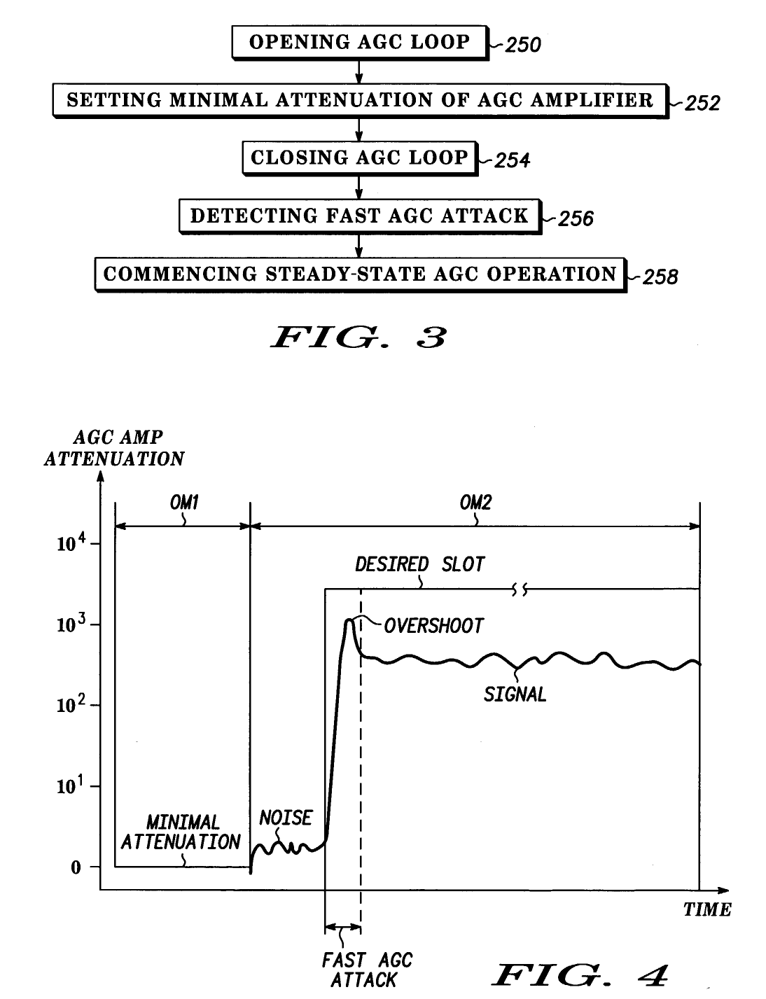

Reference is further made to FIG. 3, which is a schematic illustration of a method for operating AGC loop 200 (FIG. 1), operative in accordance with a further preferred embodiment of the present invention.

In step 250, AGC loop 200 is opened. With reference to FIG. 1, controller 226 opens switch 244, thereby disconnecting AGC detector 218 from switch 238 and driver 216.

In step 252, a minimal attenuation of AGC amplifier 210 is set. With reference to FIG. 1, controller 226 closes switches 236 and 238. Voltage source V_{PRESET} 234 charges integrating capacitor C_{AGC} 232. The time required for charging integrating capacitor C_{AGC} 232 is specified by a product of the values of damping resistor R_{AGC} value and integrating capacitor C_{AGC} 232. Controller 226 opens switch 236 when charging of integrating capacitor C_{AGC} 232 is completed. The voltage from charged integrating capacitor C_{AGC} 232 is provided to AGC amplifier 210 via damping resistor R_{AGC} 230, switch 238 and driver 216. The voltage value is determined so that the attenuation of AGC amplifier 210 will be minimal.

In step 254, AGC feedback loop is closed. With reference to FIG. 1, controller 226 closes switch 244, thereby closing the AGC feedback loop. AGC detector 218 receives a baseband signal, produces an output signal and provides it to integrating capacitor C_{AGC} 232 via switches 244 and 238. Since this operation is performed at time instances preceding the signal slot, AGC detector 218 will typically detect an ambient noise of the system.

In step 256, a signal burst is detected which initiates a fast AGC attack. With reference to FIG. 1, the system works with the closed AGC feedback loop. AGC detector 218 determines a level of the sum of squares of the I and Q signals, and provides the output DC signal to integrating capacitor C_{AGC} 232, via switches 244, 238 and damping resistor R_{AGC} 230. The voltage at integrating capacitor C_{AGC} 232 determines the gain of AGC amplifier 210. At the beginning of the signal slot, AGC detector 218 will detect a fast increase of a signal level. The resulting signal level may exceed the predetermined, desired threshold. With reference to FIG. 2, for large signals that greatly exceed the desired AGC threshold, both the gain of the AGC detctor 218 and the bandwidth of the AGC loop are maximal. Consequently, the response time of the AGC feedback loop is minimal. As the signal approaches the desired threshold, the gain of AGC detector 218 decreases. This enables the system to proceed to the steady state operation mode with a minimal overshooting.

In step 258, the system proceeds to the steady state operation mode. With reference to FIG. 1, after detecting the signal burst, AGC loop 200 rapidly reduces the gain of the AGC amplifier 210. As a result, the output baseband signal level approaches the desired value. AGC detector 218 continues to monitor and adjust the signal level within a comparatively narrow value range, close to the AGC threshold. This steady state operation mode continues until the end of the signal slot.

Reference is further made to FIG. 4, which is a schematic illustration of different operation modes of AGC loop 200 in accordance with a further preferred embodiment of the present invention (FIG. 1). The first operation mode (OM1) corresponds to steps 250 and 252 of FIG. 3. At these steps, the AGC feedback loop is closed and the attenuation of AGC amplifier 210 is set to a minimal level. The second operation mode (OM2) corresponds to steps 254, 256 and 258 of FIG. 3. In this mode, AGC detector 218 of FIG. 1 monitors the signal level and controls the loop gain accordingly. At the beginning of the signal slot there is a short period of the fast AGC attack, accompanied by an overshoot. The duration of the fast AGC attack is typically less than 0.2 ms. Right after, the system recovers from the overshoot and continues to operate in the steady state mode until the end of the signal slot.

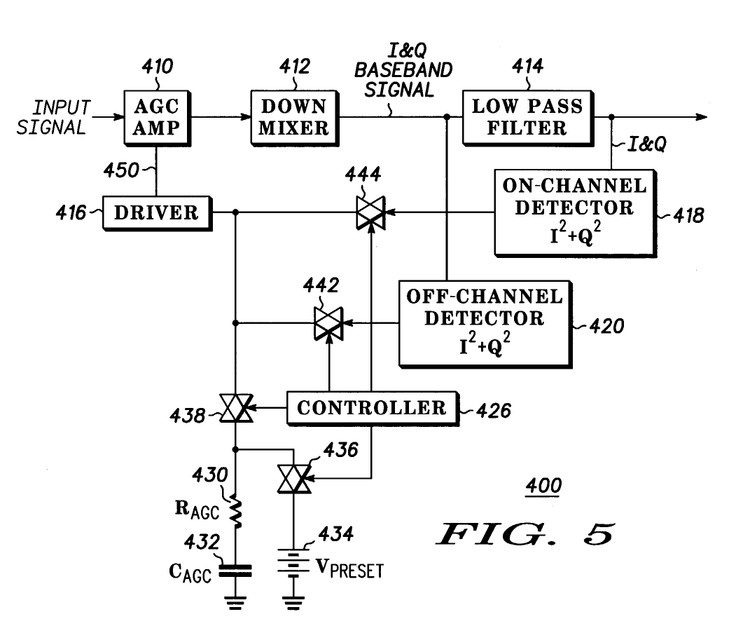

Reference is now made to FIG. 5, which is a schematic illustration of a fast attack AGC loop, generally referenced 400, constructed and operative in accordance with a further preferred embodiment of the present invention.

AGC loop 400 includes an AGC amplifier 410, a down mixer 412, a driver 416, a low-pass filter 414, an on-channel detector 418, an off-channel detector 420, a controller 426, a damping resistor R_{AGC} 430, an integrating capacitor C_{AGC} 432, a voltage source V_{PRESET} 434 and four switches 436, 438, 442 and 444. AGC amplifier 410 is coupled to down mixer 412 and to driver 416. Low-pass filter 414 is coupled to down mixer 412 and to on-channel detector 418. On-channel detector 418 is coupled to switch 444. Off-channel detector 420 is coupled to down mixer 412 and to switch 442. Controller 426 is coupled to switches 436, 438, 442 and 444. Driver 416 is coupled to switches 438, 442 and 444. Voltage source V_{PRESET} 434 is coupled to switch 436. Damping resistor R_{AGC} 430 is coupled to integrating capacitor C_{AGC} 432 and to switch 438.

AGC loop 400 includes a forward transmission path and two feedback loops, coupled from the forward path. The forward transmission path includes AGC amplifier 410, down mixer 412 and low-pass filter 414. The input for the forward transmission path is an RF signal, and the output is a baseband signal having in phase (I) and quadrature (Q) components. The first feedback loop includes off-channel detector 420, which is connected to the forward path between the down mixer 412 output and low-pass filter 414 input. Off-channel detector 420 controls the amplitude of adjacent channel (undesired) signals in the forward path. The second feedback loop includes an on-channel detector 418, which is connected to the forward path at the output of low-pass filter 414. On-channel detector 418 controls the amplitude of on-channel (desired) signals in the forward path. Off-channel detector 420 and on-channel detector 418 provide their respective output signals to integrating capacitor C_{AGC} 432. Driver 416 controls the gain of AGC amplifier 410 by providing a control signal 450. An exemplary dependence of the attenuation of AGC amplifier 410 on the voltage on integrating capacitor C_{AGC} 432, can be a linear dependence of the decibels of attenuation on voltage. It is noted that there can be other types of dependencies of the attenuation of AGC amplifier 410 on the voltage on integrating capacitor C_{AGC} 432. The value of control signal 450 depends on the operation mode of AGC loop 400. Detailed description of each of the operation modes is presented below.

At the beginning of the first operation mode, which corresponds to time instances preceding the signal slot, AGC loop 400 is open. Consequently, the feedback loops are not operative. Controller 426 opens switches 442 and 444 and closes switches 436 and 438. Voltage source V_{PRESET} 434 charges integrating capacitor C_{AGC} 432. The voltage value is determined so that the attenuation of AGC amplifier 410 will be minimal. The time period which is required for charging integrating capacitor C_{AGC} 432 is specified by a product of the value of damping resistor R_{AGC} 430 and the capacitance value of integrating capacitor C_{AGC} 432. The first operation mode is terminated when the charging of integrating capacitor C_{AGC} 432 is completed.

At the beginning of the second operation mode, controller 426 opens switch 436, thereby disconnecting voltage source V_{PRESET} 434 from integrating capacitor C_{AGC} 432. The remainder of the charge at integrating capacitor C_{AGC} 432 defines the value of control signal 450 and, hence, the gain (or attenuation) of AGC amplifier 410. Controller 426 further closes switches 444 and 442, thereby closing AGC feedback loop. Off-channel detector 420 monitors undesired signal at adjacent channels. The gain of this detector is determined so that it reacts only to strong off-channel signals, which are outside the pass band of low-pass filter 414. Off-channel detector 420 provides the output signal to integrating capacitor C_{AGC} 432, via switches 442 and 438 and damping resistor R_{AGC} 430. On-channel detector 418 monitors the desired baseband signal, and provides the respective output signal to integrating capacitor C_{AGC} 432, via switches 444 and 438 and damping resistor R_{AGC} 430. The response shape of detectors 418 and 420 depends in a non-linear manner on the signal level and the response of each can be described by equation (1). The graphical illustration of this dependence is presented in FIG. 2. The bandwidth of AGC loop 400 also depends on the signal level. Since in the DMO mode the slot, which precedes a signal slot, is generally empty, AGC loop 400 must be able to adapt itself to very fast changing signal levels at the beginning of the signal slot. The signal rise time period can be less than 0.2 ms and the dynamic range of the signal can exceed 80 dB. This requires the loop bandwidth to be maximal for high level signals, so that the AGC attack (settling) time would be less than 0.2 ms. Typically, the dependence of the loop bandwidth on the signal level can be proportional to the derivative of the loop gain with respect to the signal level, and is described by equation (2). Since the beginning of the second operation mode falls in time instances preceding the signal slot, off-channel detector 420 and on-channel detector 418 will first detect an ambient noise of the system. Upon detection of this signal, both detectors provide a respective output signal to AGC amplifier 410, thereby adjusting the attenuation of the signal. In the second operation mode, both detectors detect the beginning of the signal slot, which is accompanied by a sharp increase in the signal level. According to equations (1), (2) and FIG. 2, the gain of bothe on-channel detector 418 and off-channel detector 420 are maximal for large, rapidly varying signals. Thus the loop bandwidth of AGC loop 400 will be maximal. Consequently, the response time of the AGC feedback loop is minimal. As the signal approaches the desired threshold, the gain of on-channel detector 418 and of off-channel detector 420 decrease. This enables the system to proceed to the steady state operation with a minimal overshooting. The second operation mode is completed at the end of the signal slot. It is noted that the method illustrated in FIG. 3 can be used for operating AGC loop 400.

It will be appreciated by persons skilled in the art that the present invention is not limited to what has been particularly shown and described hereinabove. Rather the scope of the present invention is defined only by the claims, which follow.

1. An automatic gain control (AGC) circuit comprising:
a forward transmission path operable in use (i) to receive applied at its input a RF signal being provided in a plurality of signal time slots wherein pairs of adjacent slots are interleaved by at least one empty slot and (ii) to provide at its output a baseband signal;
a variable gain amplifier in the forward transmission path which amplifier has a control input and is responsive to a control signal applied thereto to vary its gain;
a feedback loop, coupled from an output of said forward transmission path to said control input of said variable gain amplifier;
an integrator coupled to said control input of said amplifier; and,
a voltage source, coupled to said integrator and to said control input of said amplifier, and
wherein said feedback loop incorporates a signal detector that has a predetermined non-linear gain response, depending on an input signal level, said gain being higher for high-level signals and lower for low-level signals.

2. An AGC circuit according to claim 1 and wherein the forward path includes a low pass filter and at least two feedback loops connected between the forward transmission path and the control input to the amplifier, including a first feedback loop connected to the forward transmission path before the low pass filter and a second feedback loop connected to the forward transmission path after the low pass filter, each of the feedback loops incorporating a signal detector.

3. An AGC circuit according to claim 1, wherein said baseband signal includes as phase components an in-phase (I) component and a quadrature (Q) component.

4. An AGC circuit according to claim 3, wherein each said signal detector comprises an AGC detector, which in use receives said baseband signal and provides an output signal to said control input of said amplifier, said output signal being related to a non-linear combination of said I and Q components of said baseband signal.

5. An AGC circuit according to claim 2, wherein a dependence of the gain G of the or each said signal detector on the level S of said baseband signal presented thereto is represented by:
G=G₀+kS^{1+r}
where G₀, k and r are predetermined parameters.

6. An AGC circuit according to claim 2, wherein a response of each said signal detector, to changes in the level of the baseband signal presented thereto, is to provide an output signal of variable bandwidth, wherein said variable bandwidth is higher for high-level input signals, and wherein said variable bandwidth is lower for low-level input signals.

7. An AGC circuit according to claim 6, wherein a dependence of said variable bandwidth BW on the level S of the input baseband signal is represented by:
BW=A.k.(1+r)S^{r}
where A. k and r are predetermined parameters.

8. An AGC circuit according to claim 2 which includes a first feedback loop connected to the forward transmission path in a position before the low pass filter and a second feedback loop connected to the forward transmission path in a position after the low pass filter, each of the feedback loops incorporating a signal detector, wherein the signal detector of the feedback loop which is connected to the forward transmission path before the low pass filter has a signal detection threshold which is different from the signal detection threshold of the signal detector of the the feedback loop which is connected to the forward transmission path after the low pass filter.

9. An AGC circuit according to claim 1, wherein said integrator comprises an integrating capacitor and a resistor, the integrating capacitor having an output through the resistor coupled to said control input of said AGC amplifier.

10. An AGC circuit according to claim 1, wherein said voltage source provides a predetermined voltage to said integrator, thereby determining a level of said control signal, wherein the level of said control signal is chosen so that an attenuation of said AGC amplifier is substantially minimal, and wherein the voltage source provides said predetermined voltage for a predetermined preset time period beginning at a predetermined time instant.

11. An AGC circuit according to claim 1, which includes switching means operable to allow the AGC circuit to be switched between an open mode of operation in which the feedback loop is not operational and a closed mode of operation in which the feedback loop is operational, such modes being obtained at predetermined times for predetermined time periods, wherein the AGC loop is set to an open mode of operation after the end of a signal slot and preceding a further signal slot, and wherein said AGC loop is set to a closed mode of operation at time instances following the end of said preset time period and preceding said selected signal slot.

12. A radio frequency (R.F.) receiver including an AGC circuit according to claim 1.

13 A R.F. receiver according to claim 12, wherein the receiver is operable to receive RF signals provided in a plurality of signal time slots, each pair of adjacent signal time slots being interleaved by at least one empty time slot.

14. A R.F. receiver according to claim 13, wherein the AGC circuit has an open mode of operation in which the or each feedback loop is not operational and a closed mode of operation in which the or each feedback loop is operational, such modes being obtained at predetermined times for predetermined time intervals corresponding to a pattern of the signal time slots and empty time slots.

15. A R.F. receiver according to claim 14, wherein the voltage source of the AGC circuit is operable to provide in the open mode of the or each feedback loop a predetermined voltage for a predetermined time period beginning at a preset time after the end of each signal slot.

16. A R.F. receiver according to claim 12, wherein the AGC circuit is operable to be set to an open mode of operation after the end of each signal slot and to a closed mode of operation.

17. A method for operating an automatic gain control (AGC) loop in a narrow band receiver, the receiver being in idle mode, the AGC loop having an amplifier responsive to reception of a control signal having an amplitude, the narrow band receiver receiving an RF signal, the RF signals being provided in a plurality of signal time slots, each pair of adjacent signal time slots being interleaved by at least one empty time slot, the method comprising the steps of:
setting the AGC loop to an opened operation mode;
setting the control signal amplitude to a predetermined value; and,
setting the AGC loop to a closed operation mode.

18. The method according to claim 17, wherein the AGC loop is set to be in said opened operation mode after the end of a predetermined signal slot.

19. The method according to claim 18, wherein the step of setting the control signal amplitude to said predetermined value further includes the steps of:
setting said control signal amplitude to a value corresponding to a minimal attenuation in said AGC loop, thereby completing a preset period.

20. The method according to claim 18, wherein said AGC loop is set to a closed operation mode after the end of said preset period and prior to a following signal slot.

21. The method according to claim 14 wherein the AGC loop includes an AGC amplifier and a feedback loop to control the gain of the amplifier, the feedback loop incorporating a signal detector that has a predetermined non-linear gain response, depending on an input signal level, said gain being higher for high-level signals and lower for low-level signals.
